(19) United States
(12) Patent Application Publication
(10) Pub. No.: US 2025/0291657 A1
(43) Pub. Date: Sep. 18, 2025

(54) HARDWARE-BASED INTER-PROCESSING COMMUNICATION NETWORKS FOR MANAGED DEVICES

(71) Applicant: NVIDIA Corporation, Santa Clara, CA (US)

(72) Inventors: Varun Sampath, Santa Clara, CA (US); Abhishek Basak, Bothell, WA (US); Rahul Jain, Bangalore (IN); Durga Prasad Potnuru, Bangalore (IN); Akash Singh, Bangalore (IN)

(21) Appl. No.: 18/606,893

(22) Filed: Mar. 15, 2024

(51) Int. Cl. G06F 9/54

(52) U.S. Cl. CPC G06F 9/547; G06F 9/546

(57) ABSTRACT

Disclosed are apparatuses, systems, and techniques that implement software-agnostic transport of messages to, from, and within managed devices. In one embodiment, a managed device has an intra-device network including a plurality of units, each unit associated with a unit controller. The managed device further includes a hub controller that receives data packet(s) jointly carrying a message from an external host. The controller identifies that the one or more first data packets are associated with a given unit and forwards the data packet(s) to the corresponding unit controller. The unit controller extracts the message from the data packet(s) and stores the message in a memory associated with the unit controller.

### TECHNICAL FIELD

At least one embodiment pertains to processing resources and techniques that are used to improve efficiency, interoperability, and security of inter-processor communications in computational applications. For example, at least one embodiment pertains to hardware-based networks for managing inter-processing communications.

### BACKGROUND

Modern processing devices, such as central processing units (CPUs), graphics processing units (GPUs), parallel processing units (PPUs), and/or similar processing devices, are typically equipped with microcontrollers that implement various support functions and control over the processing devices. For example, a specialized baseboard management controller may be embedded into the same chip or board that contains the processing device. The management controller includes logic circuitry and memory and operates responsive to instructions stored in firmware to provide an interface between system-management software, e.g., operation system and BIOS, and the managed processing device. The management controller facilitates security and efficient management of processing devices, network controllers, and/or the like. As the complexity of processing devices increases, various controller functions and their embodiments likewise become increasingly more complex.

### BRIEF DESCRIPTION OF DRAWINGS

FIG. 1 is a schematic block diagram of an example computing system capable of deploying networks of microcontrollers for managing one or more component devices, according to at least one embodiment;

FIG. 2 is a schematic block diagram of a portion of an example managed device that is managed using a network of microcontrollers, according to at least one embodiment;

FIG. 3 illustrates an example data flow in a network of microcontrollers of an example managed device, according to at least one embodiment;

FIG. 4 illustrates an example data flow inside a network microcontroller of the network of FIG. 3, according to at least one embodiment;

FIG. 5 is a flow diagram of an example method of transporting incoming messages to a network of microcontrollers deployed to facilitate and control operation of a managed device, according to at least one embodiment;

FIG. 6 is a flow diagram of an example method of handling outbound messages in a network of microcontrollers deployed to facilitate and control operation of a managed device, according to at least one embodiment;

FIG. 7 depicts a block diagram of an example computer device capable of supporting software-agnostic transport of messages to, from, and within managed devices, according to at least one embodiment.

### DETAILED DESCRIPTION

The management controller (MC) manages power usage and memory allocation for the processing device, implements security features, supports input-output (IO) functions, e.g., PCI Express (PCIe), and performs other functions. The MC collects data from various sensors built into the processing device, including temperature data, cooling fan speed data, power status data, operating status data, and/or other telemetry data to ensure that the various processing device metrics remain within target ranges. In the instances where the metrics indicate a potential failure of the device or a departure from the target ranges, the MC can alert the OS or a system administrator of the computing system that deploys the device so that a corrective action can be taken, e.g., resetting or power cycling the processing device, reducing processing load of the device, and so on. This increases the deployment efficiency of the processing device and reduces its operational overhead and costs.

Various sensors and other devices (referred to as “units” herein) located inside the processing devices may be managed by microcontrollers that communicate with the MC. Communications between the OS and the MC and the MC and a managed device (e.g., a processing device or a network controller) may be performed according to an industry-standard protocol, e.g., the Management Component Transport Protocol (MCTP), which specifies a format for communicated messages, transport description, message exchange patterns, operational endpoint characteristics, and/or the like. On the other hand, communications within the managed device can be performed according to any suitable format, including a proprietary format of a manufacturer of the managed device. A given computing system may deploy multiple processing devices, each deploying a special communication format, different software and/or firmware, security rules, and/or the like. As a result, the overhead and the cost of managing all such diverse infrastructure can be quite considerable. Furthermore, performing security monitoring and analysis of operations of multiple heterogeneous processing devices may be very complex. For example, a computing system (e.g., a data center) communicating with multiple processing devices may have to re-format and re-buffer messages at multiple hubs or transfer points of the communication fabric. This increases complexity and reduces performance of the computing system.

Aspects and embodiments of the instant disclosure address these and other technological challenges by disclosing methods and systems that support efficient delivery of messages to and from various units of managed devices while taking advantage of the existing common protocols (e.g., MCTP) in a way that allows external software (e.g., the OS of a host device) to remain agnostic about transport of messages inside the managed devices. In one example embodiment, a managed device (e.g., a CPU, GPU, network controller, and/or some other device) may have an intra-device messaging network that includes a hub unit and one or more peripheral units, e.g., a power management unit (PMU), foundation security processor (FSP), GPU system processor (GSP), and/or the like. The hub unit (also referred to simply as “hub” herein) may serve as a router/bridge for messages delivered to and from the units and efficiently route messages to their correct destinations. More specifically, a message to the PMU may be fragmented over multiple packets received by the hub unit. Instead of unpacking and buffering various portions of the message and forwarding the complete assembled message to the PMU, the hub unit may route the packets to the PMU directly. At the same time, various additional packets with messages to other units may be similarly forwarded to their intended destinations (e.g., the FSP unit, GSP unit, etc.) regardless of whether such packets arrive sequentially or interspaced with the PMU-bound packets.

Having received and unpacked the PMU-bound packets, a microcontroller of the PMU may assemble the complete messages and store the message in the unit's memory (e.g., cache, buffers, etc.) before taking a suitable action, e.g., causing a hardware interrupt or a software exception. As a result, the software/firmware running on the PMU microcontroller (and, similarly, on microcontrollers of other units) need only be informed that the message has arrived but can remain agnostic about how the specific packets containing portions of the message were handled by the hub unit. In some embodiments, the handling of the packets may be performed by the microcontroller of the hub unit using one or more hardware circuits. This ensures fast and secure packet processing. For example, a packet may include a header (e.g., a 4-byte MCTP header) and a payload (e.g., a 64-byte message or portion of a message). A hub microcontroller receiving an inbound message (e.g., from the MC) may use a circuitry that reads the packet header, checks a source address and a destination address of the packet and directs the packet to a correct unit of the managed device. In the instances where the source address and/or the destination address is incorrect, e.g., do not comply with a security policy, the hub microcontroller may drop the packet. Similarly, the microcontrollers of the units may perform the security checks before accepting and storing the received messages. Since the hub does not need to store more packets than can physically arrive and accumulate during processing of a single packet, the hub does not need to have a large amount of cache as the received packets can be stored in the memory of individual units. Microcontrollers of the individual units may use direct memory access (DMA) reads to store messages received from the hub microcontroller.

Transport of outbound messages communicated in the opposite direction—from individual units—may occur in a similar manner, with microcontrollers of individual units using DMA reads to fetch stored messages (e.g., telemetry data) from the caches of individual units, formatting the outbound messages into packets (e.g., by fragmenting the outbound messages, adding headers, and/or the like) and sending the outbound messages to the hub. The hub microcontroller may read source/destination addresses, check compliance with the security protocols, and forward the outbound messages to the MC.

The advantages of the disclosed techniques include, but are not limited to, fast and secure hardware-facilitated communications between host devices and various managed devices. The network of microcontrollers—of the hub and various individual units of the managed devices—provides a programming framework that abstracts away the underlying message transport mechanism while supporting standardized external communication protocols (e.g., MCTP). The network of microcontrollers implements strong security measures as the messages are communicated directly to/from recipient units and devices without relying on software. The network of microcontrollers may utilize the existing IO fabric for message transport and, therefore, comes at no additional cost to system developers and administrators.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as large language models (LLMs) (which may process text, voice, image, and/or other data types to generate outputs in one or more formats), systems implemented at least partially using cloud computing resources, systems for performing generative Al operations, and/or other types of systems.

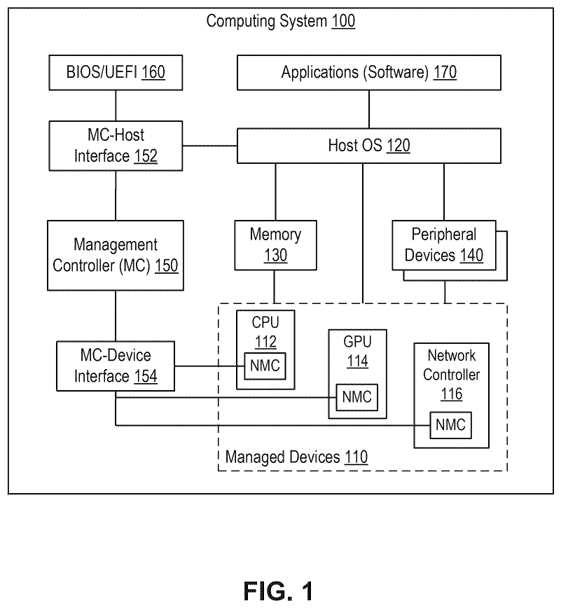

FIG. 1 is a schematic block diagram of an example computing system 100 capable of deploying networks of microcontrollers for managing one or more component devices, according to at least one embodiment. As depicted in FIG. 1, computing system 100 may include one or more managed devices 110, such as one or more CPUs 112, one or more GPUs 114, one or more network controllers 116, and/or other component devices (not shown in FIG. 1 for conciseness), as may be deployed by computing system 100, e.g., data processing units (DPU), parallel processing units (PPU), multimedia processors, neural network accelerators, field-programmable gate arrays (FPGA), application-specific integrated circuits (ASIC), and/or the like. Individual managed devices 110 may include respective networks of microcontrollers (NMC). In some embodiments, an NMC may be implemented on the same chip as the managed device deploying the corresponding NMC. In some embodiments, multiple managed devices 110 (e.g., a CPU and a GPU) may be implemented on the same chip. In such embodiments, a single NMC may be used to manage multiple managed devices 110. Alternatively, a separate NMC may be used to manage each device even when more than one managed device 110 resides on the same chip.

In some embodiments, managed devices may be managed using a management controller (MC) 150, which may include logic circuitry and internal memory (not shown) storing instructions (e.g., firmware and/or software instructions) that implement management functionality of MC 150. In some embodiments, MC 150 may be embedded in a motherboard that hosts one or more managed devices 110. In some embodiments, MC 150 may be a baseboard management controller (BMC). MC 150 may communicate with a host via an MC-host interface 152 and may communicate with managed devices 110 via an MC-device interface 154. In some embodiments, MC-host interface 152 and MC-device interface 154 may use the same communication protocol, e.g., MCTP or some other protocol. MC-host interface 152 may facilitate interaction with a host operating system (OS) 120 and with Basic Input/Output System (BIOS) or Unified Extensible Firmware Interface (UEFI). For example, BIOS/UEFI 160 may provide instructions for MC 150 during the booting process and may pass control over MC 150 to host OS 120 after the booting process has been completed. In one example embodiment, when computing system 100 is being powered up (or rebooted), BIOS/UEFI 160 may generate instructions to MC 150 to begin configuring and monitoring operations of various managed devices 110, including but not limited to selecting power and security settings for managed devices 110, initializing address space of CPU 112, GPU 114, network controller 116, monitoring temperature and clock frequencies of CPU 112 and GPU 114, collecting network metrics from network controller 116, and/or the like. After host OS 120 is instantiated and has begun executing one or more application 170, subsequent instructions to MC 150 may be generated by host OS 120. For example, once a particular security-sensitive application has been started by host OS 120, security settings for one or more managed devices 110 may change. Correspondingly, host 120 may indicate to MC 150 that additional security of CPU 112 and/or GPU 114 is required and/or that network controller 116 is to encrypt an outbound data traffic using a particular private key. During execution of applications 170, host OS 120 may use system memory 130 and any number of peripheral devices 140, e.g., displays, printers, cameras, speakers, microphones, input-output devices (keyboards, pointing devices, touchscreens, and/or the like), sensors (e.g., Mobile Industry Processor Interface sensors communicating over a Gigabit Multimedia Serial Link), and so on. In some embodiments, host OS 120 may support any number of virtual machines (each having a separate guest OS), container-based execution, remote-access execution, and/or the like.

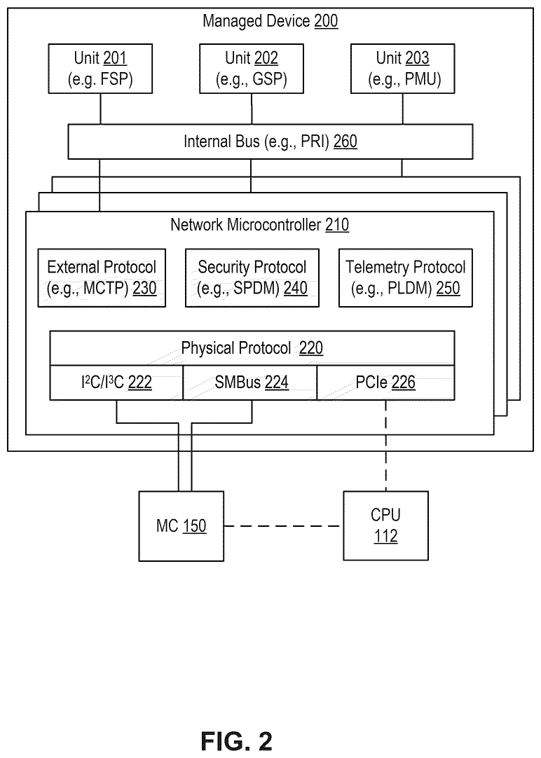

FIG. 2 is a schematic block diagram of a portion of an example managed device 200 that is managed using a network of microcontrollers, according to at least one embodiment. Managed device 200 may be any suitable processing device, e.g., a CPU, a GPU, etc., a network controller, and/or any other managed computing component. It should be understood that managed device 200 may have any number of additional elements not explicitly shown in FIG. 2 for brevity and conciseness. For example, in the instances where managed device 200 is (or includes) a CPU, managed device 200 may have one or more arithmetic logic units (ALUs), a control circuit, a memory management unit, an encryption accelerator circuit, control registers, high-speed cache, and/or other components that are not shown explicitly in FIG. 2. Similarly, in the instances where managed device 200 is (or includes) a GPU, managed device 200 may have multiple GPU cores, GPU memory, registers, and/or the like.

In some embodiments, management of managed device 200 may be facilitated by MC 150. Managed device 200 may include multiple units (circuits, devices, etc.) that facilitate configuration, security, and data collection associated with managed device 200. In one illustrative non-limited example, managed device 200 may include units 201, 202, 203, and/or the like. For example, Unit 201 may be (or include) a Foundation Security Processor (FSP), e.g., a root of trust (RoT) unit responsible for implementing security of managed device 200 and protection of data handled by managed device 200. Unit 202 may be (or include) a GPU system processor (GSP) that can be used to offload GPU initialization and management tasks. Unit 203 may be (or include) a power management unit (PMU) responsible for power settings of managed device 200, including but not limited to monitoring power connections, charging batteries, controlling power provided to various GPU or CPU processing cores, controlling sleep, shut down, and awakening functions, and/or the like.

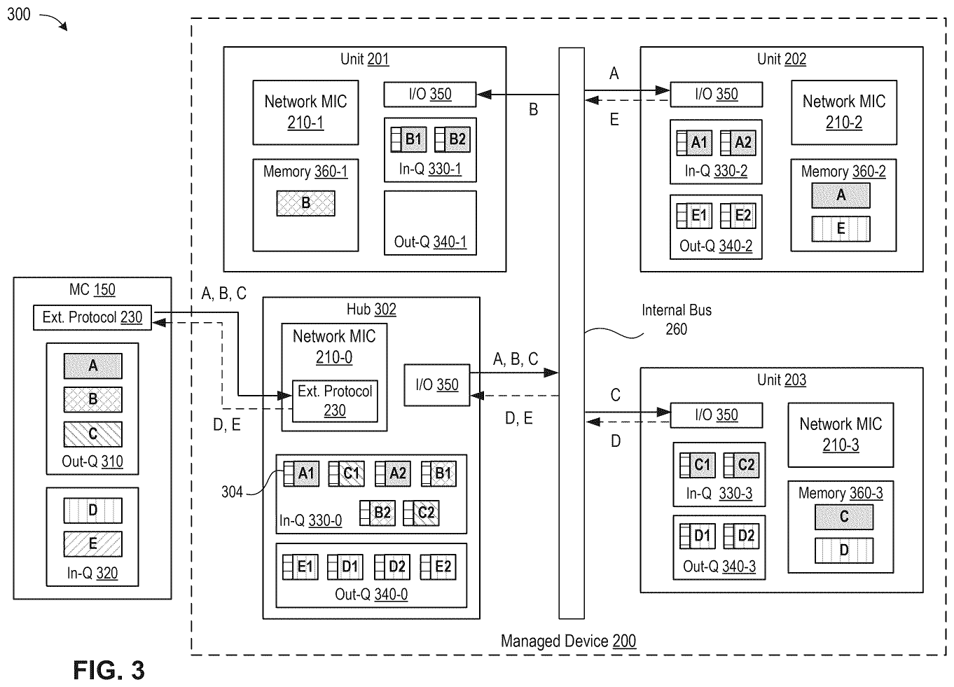

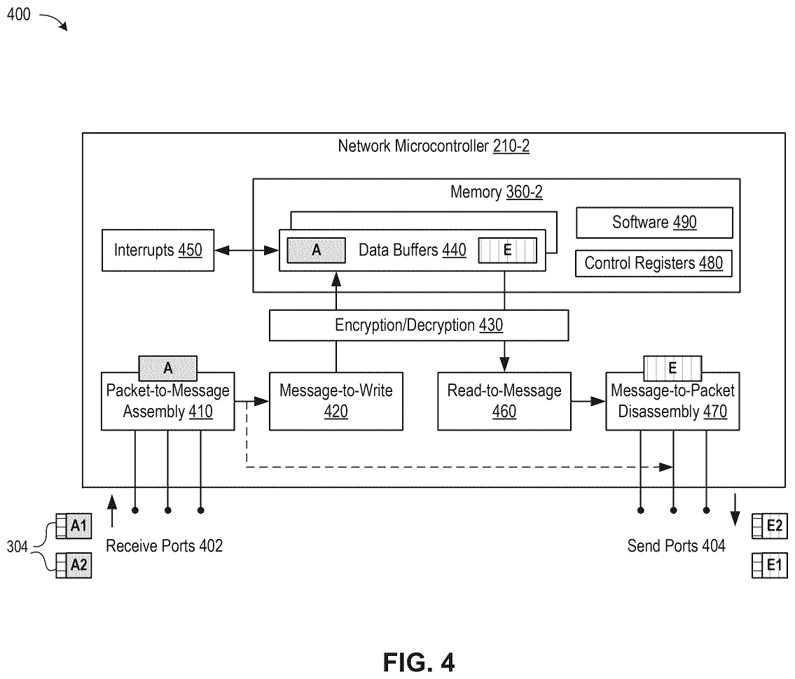

Managed device 200 may include multiple network microcontrollers 210 to support internal (e.g., Unit-to-Unit) and external (e.g., managed device-to-MC) communications. In some embodiments, each unit 201, 202, etc., may have a separate network microcontroller 210. Additional network microcontrollers 210 may serve multiple individual units of the managed device and/or the device as a whole, e.g., a hub microcontroller, as disclosed in more detail in conjunction with FIG. 3 and FIG. 4.

Individual network microcontrollers 210 may support a suitable physical protocol 220 supporting communications of the microcontroller via a suitable physical medium (e.g., wires or radio waves) that connect managed device 200 to MC 150. Physical protocol 220 may support any number of communication busses (interconnects), such as Inter-Integrated Circuit (I²C) bus, Improved Inter-Integrated Circuit (I³C) bus, System Management bus (SMBus) 224, PCIe bus 226, and/or the like. In some embodiments, some of the busses (e.g., I²C bus/I³C bus 222, as illustrated in FIG. 2) may facilitate direct connection between managed device 200 and MC 150. In some embodiments, some of the busses (e.g., PCIe bus 226) may be used for an indirect, e.g., mediated by CPU 112, connection between managed device 200 and MC 150.

Individual network microcontrollers 210 may further support external protocol 230, e.g., MCTP, to support communications with other hardware components (e.g., other processing devices) and software (e.g., host OS) implementing a common management platform. External protocol 230 and may specify a format of messages, message exchange patterns, operational endpoint characteristics, transport descriptions, and/or the like., and may be independent of the underlying physical protocol 220.

Individual network microcontrollers 210 may further support a security protocol 240, e.g., Security Protocol and Data Model (SPDM), and/or the like. Security protocol 240 may define (e.g., according to the protocol specification) messages, data objects, and sequences for performing message exchanges between devices, authentication of components, firmware measurement and protection of data in flight, and/or the like.

Individual network microcontrollers 210 may further support a telemetry protocol 250, e.g., Platform Level Data Model (PLDM) protocol and/or the like. Telemetry protocol 250 may define data representations and commands for collecting and communicating temperature, voltage, fan speed, network throughput and latency, and/or any other telemetry data.

Network microcontrollers 210 may also support an internal bus 260 for exchanging data with other network microcontrollers 210. In one example embodiment, internal bus 260 may be a Privileged Register Interface bus, and/or a similar bus.

In some embodiments, various protocols and interconnects shown in FIG. 2 may be implemented using hardware circuitry. For example, protocols and interconnects depicted with shaded boxes may be hardware-implemented. In some embodiments, telemetry protocol 250 may be software-implemented.

FIG. 3 illustrates an example data flow 300 in a network of microcontrollers of an example managed device, according to at least one embodiment. As illustrated in FIG. 3, an MC 150 may communicate data with managed device 200, e.g., using any suitable external protocol 230 (MCTP, etc.). Managed device 200 may include Units 201, 202, 203, and the like (the number of individual units is not limited) and a hub 302 to forward data packets between the Units and MC 150. Hub 302 and the Units may include respective microcontrollers 210-0, 210-1, 210-2, . . . , joined in a network over a suitable internal bus 260.

Each Unit may serve as an endpoint of the network and may be assigned a unique hardcoded endpoint identifier (EID). Hub 302 may be given a separate EID. MC 150 may maintain an outbound queue (out-queue) 310 of messages A, B, C . . . addressed to various Units of managed device 200. A message may be identified by an EID of a destination unit DEST_EID, a TAG (e.g., a unique identifier of a message), TO (TAG owner, e.g., a bit or some other value identifying whether the TAG was originated by the source or the destination of the message.), and/or any other applicable identifying information. Messages A, B, C . . . may be sent to hub 302 over any suitable physical protocol (e.g., I²C, I³C, PCIe, SMBus, and/or the like) in an order of generation of the messages by MC 150 or in any other order as may be scheduled by MC 150.

Hub 302 serves as a router/bridge for messages A, B, C . . . delivered to and from the Units and efficiently route messages to correct destinations. For example, message A may be addressed to Unit 202, message B may be addressed to Unit 201, and message C may be addressed to Unit 203. Messages may be received by hub 302 being fragmented into multiple packets, e.g., message A may be fragmented into packets A1 and A2, message B may be fragmented into packets B1 and B2, and so on. (For conciseness, messages are shown fragmented into two packets in FIG. 3, but messages of any other length can be communicated using the same or similar techniques.) Network microcontroller 210 of hub 302 may check headers 304 of the incoming packets and route (forward) the packets to the appropriate destination Units. The packets may be processed in the order in which the packets are received by hub 302 and placed into an inbound queue (in-queue) 330-0. For example, as illustrated, packets are received in the order A1, C1, A2, B1, B2, C2, etc. Network microcontroller 210-0 may check source SRC_EID and destination DEST_EID of each packet and enforce any applicable security policy by dropping the packets having incorrect source or destination. For example, when a message's destination is the PMU but SRC_EID associated with the message is not among a list of sources that are trusted to communicate with the PMU, the message may be dropped and not delivered to the PMU. Network microcontroller 210-0 forwards packets A1 and A2 to Unit 202, packets B1 and B2 to Unit 201, packets C1 and C2 to Unit 203, and so on. In some embodiments, messages received from outside the managed device 200 may be directed to a DEST_EID that is different from the actual destination of the messages. For example, outside devices, e.g., MC 150, host OS, and/or the like, may be given EID of hub 302 such that messages directed to various Units list the given EID. This reduces exposure of the internal address space of managed device 200 to MC 150 and/or other external entities. When hub 302 receives a message, network microcontroller 210-0 of hub 302 may read the header of the message and determine that the actual recipient is one of the Units 201, 202, etc. Network microcontroller 210-0 may then route the message to the correct destination (e.g., the PMU).

Hub 302 may have a limited amount of storage that is sufficient to store a maximum number of packets that can arrive (and accumulate) during processing of a single packet. For example, if routing of a single packet of size l (e.g., in bytes) takes time t₀ and a bandwidth of connection to MC 150 is b bytes per second, it is sufficient to limit memory of hub 302 to l·[bt₀/l] bytes. This eliminates the need to have a large cache associated with hub 302.

In one example, network microcontroller 210-2 of Unit 202 may receive packets (e.g., packets A1 and A2) addressed to Unit 202. The packets may be received over internal bus 260 and a suitable I/O circuit 350 and placed into an in-queue 330-2. Network microcontroller 210-2 may unpack the received packets and assemble the complete message A. The assembled message may be stored in the Unit's memory 360-2. Followed by assembly and storage of the message, network microcontroller 210-2 may notify an application software recipient of the message of its successful arrival. Since handling of packets A1 and A2 and unpacking of message A can be performed by hardware circuitry of the network microcontrollers (e.g., network microcontrollers 210-0 and 210-2 in this example), the application software running on Unit 202 may be agnostic about specifics of message transport between MC 150 and Unit 202. Transport of messages B and C (via the corresponding packets B1, B2, C1, and C2) to Units 201 and 203, respectively, may be performed similarly.

Transport of messages in the opposite direction—from individual Units 201, 202, 203, etc.—may occur in a similar manner. For example, Unit 203 may prepare and store, in memory 360-3 of Unit 203, an outbound message D (e.g., network latency data or power consumption data) while Unit 202 may prepare and store, in memory 360-2 of Unit 202, an outbound message E. Network microcontroller 210-3 (and, similarly, network microcontroller 210-2) may fetch stored message E (and, similarly, message D) from the memory, fragment message E (message D) into multiple packets E1, E2, etc. (packets D1, D2, etc.), add headers to the packets and place the packets into an out-queue 340-3 of Unit 201 (out-queue 340-2 of Unit 202). Network microcontroller 210-3 (and, similarly, network microcontroller 210-2) may communicate the packets via I/O 350 and internal bus 260 to hub 302. Network microcontroller 210-0 of hub 302 receives the packets into an out-queue 340-0 and routs the received packets to MC 150 using external protocol 230. Outgoing packets D1, D2, E1, E2, etc., may be formatted according to specification of the external protocol 230 (e.g., with appropriate headers, end-of-packet, end-of message indicators, and/or the like) by network microcontrollers of the sending units (e.g., network microcontrollers 210-2 and 210-3, in this example) so that network microcontroller 210-0 of hub 302 does not have to perform any reformatting of the packets and may forward the received packets to MC 150 without delay. MC 150 may receive the packets D1, D2, E1, E2, unpack and reassemble the received packets into the compete messages D and E, and place these messages into an in-queue 320. MC 150 may then consume messages D and E (in MC 150 is the final destination) or rout messages D and E to another recipient (e.g., the host OS).

FIG. 4 illustrates an example data flow 400 inside a network microcontroller of the network of FIG. 3, according to at least one embodiment. FIG. 4 illustrates operations of network microcontroller 210-2 but any other network microcontrollers 210-n may operate in a similar way. Operations of network controller 201-2 may be managed by control registers 480. In one example, network microcontroller 210 may configure any number N of receive ports 402 and send ports 404 to receive and send packets, including but not limited to packets formatted according to external protocol 230 (with reference to FIG. 2 and FIG. 3). Receive ports 402 and send ports 404 may also be used for intra-network communications to deliver messages between different microcontrollers of the network of microcontrollers. In some embodiments, intra-network communications may use the same external protocol (e.g., MCTP) as used for external communications (e.g., with MC 150 and other devices). In some embodiments, intra-network communications may use a different internal protocol, which may be proprietary to a manufacturer of the managed device. Individual receive ports 402 may be configured with a {SRC_EID, TAG, TO} tuple causing the receive port to listen to messages arriving from a source microcontroller SRC_EID, a given TAG, and tag owner TO. Similarly, individual send ports 404 may be configured with a {DEST_EID, TAG, TO} tuple to send messages to a destination microcontroller DEST_EID, a given TAG, and tag owner TO. Receive ports 402 and send ports 404 thus form one or more communication channels that may be used to seamlessly transport messages between SRC_EID and DEST_EID devices. Multiple communication channels may be established between the same pair of endpoints SRC_EID and DEST_EID using different TAG and TO values.

In those instances where network microcontroller 210-2 is a destination endpoint of a message (e.g., message A), receive ports 402 may receive packets of the message (e.g., packets A1 and A2). Network microcontroller 210-2 may deploy a hardware circuit (or circuit group) to perform packet-to-message assembly 410, e.g., by removing packet headers 304, extracting packet payloads, and assembling the extracted payloads into a message (e.g., message A). Another hardware circuit (or a circuit group) may execute message-to-write 420 to store the message in memory 360-2, e.g., in one or more data buffers 440. In some embodiments, message-to-write 420 may be a DMA write operation. In some embodiments, prior to storing the message, network microcontroller 210-2 may deploy an encryption/decryption group to decrypt the message. In some embodiments, encryption may be applied to individual payloads by packet-to-message assembly 410. In some embodiments, encryption/decryption 430 may be performed by a software or firmware module. In some embodiments, encryption/decryption 430 may be implemented via a separate dedicated hardware circuit (or circuit group). After the received message is stored in memory 360-2, network microcontroller 210-2 may trigger an interrupt 450 to inform a recipient of the message, e.g., software 490, that the message is available for consumption.

In some embodiments, a recipient of the received message may be different from network microcontroller 210-2 with network microcontroller 210-2 serving as a bridge to the recipient. In such instances, as indicated with the dashed arrow in FIG. 4, the message may be routed to the intended recipient via one or more send ports 404.

Communication of outbound messages may be performed as follows. In one example, network microcontroller 210-2 may fetch an outbound message (e.g., message E) from memory 360-2 via read-to-message 460 circuit (or group of circuits), which may use a DMA read, in one embodiment. Network microcontroller 210-2 may deploy another hardware circuit (or circuit group) to perform message-to-packet disassembly 470, which may include fragmenting the outbound message into payloads, adding packet headers (which may include SRC_EID identifying network microcontroller 210-2 as a sender of the message, a suitable TAG, TO, and other information), and generating message-carrying packets (e.g., packets E1 and E2). The generated packets may then be sent to an intended recipient of the message over one or more send ports 404. The recipient of the message may be another network microcontroller of the same network, an external device (e.g., MC 150), a host, or some other device.

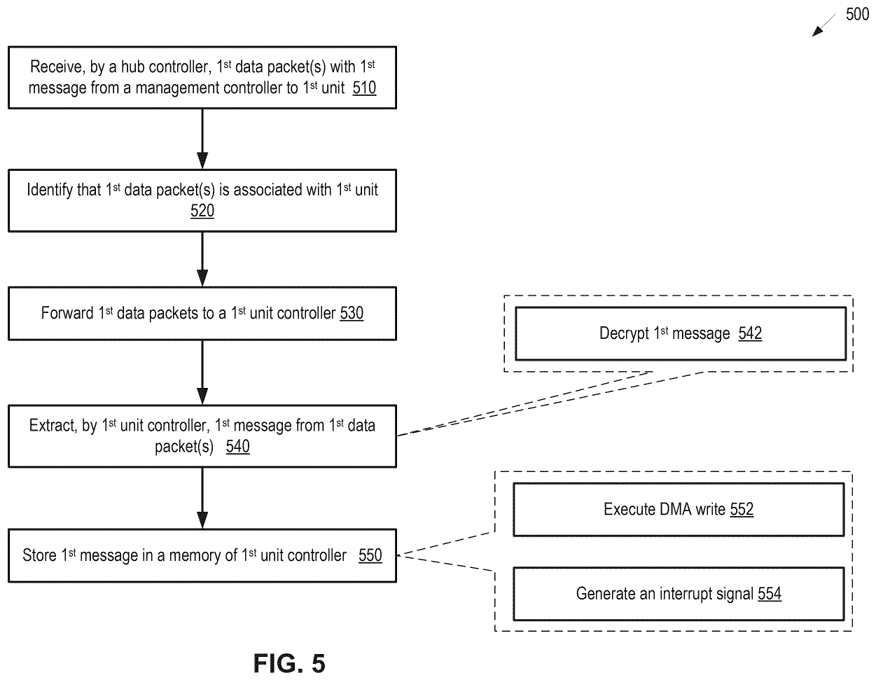

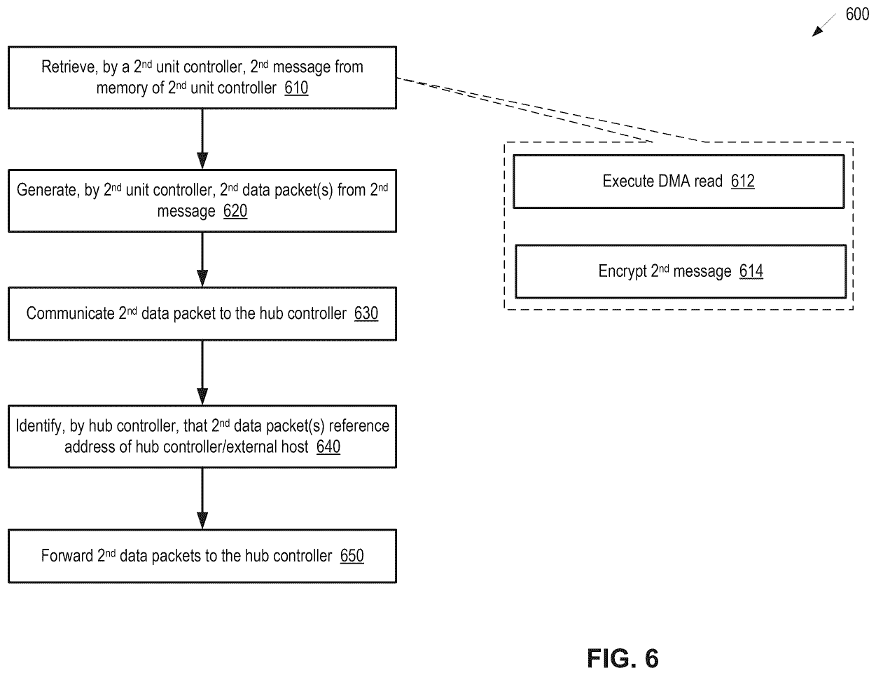

FIGS. 5-6 are flow diagrams of example methods 500 and 600 of facilitating software-agnostic transport of messages to, from, and between various units and components of managed devices, according to some embodiments of the present disclosure. Methods 500 and 600 may be performed in the context of cloud-based programming, computational simulations, autonomous driving applications, industrial control applications, provisioning of streaming services, video monitoring services, computer-vision based services, artificial intelligence and machine learning services, mapping services, gaming services, virtual reality or augmented reality services, and many other contexts, and/or in systems and applications for providing one or more of the aforementioned services. Methods 500 and 600 may be performed using one or more processing units (e.g., CPUs, GPUs, accelerators, PPUs, DPUs, etc.), which may include (or communicate with) one or more memory devices. In at least one embodiment, methods 500 and 600 may be performed using computing system 100, one or more managed devices 110, management controller 150, one or more network microcontrollers 210-n of FIGS. 1-4. In at least one embodiment, some of processing units performing any operations of methods 500 and 600 may be executing instructions (e.g., firmware or software) stored on non-transient computer-readable storage media. In some embodiments, some of the processing units performing any of the operations of methods 500 and 600 may be hardware circuits that operate without software involvement. In at least one embodiment, any of methods 500 and 600 may be performed using multiple processing threads, individual threads executing one or more individual functions, routines, subroutines, or operations of the method. In at least one embodiment, processing threads implementing any of methods 500 and 600 may be synchronized (e.g., using semaphores, critical sections, and/or other thread synchronization mechanisms). Alternatively, processing threads implementing any of methods 500 and 600 may be executed asynchronously with respect to each other. Various operations of any of methods 500 and 600 may be performed in a different order compared with the order shown in FIGS. 5 and 6. Some operations of any of methods 500 and 600 may be performed concurrently with other operations. In at least one embodiment, one or more operations shown in FIGS. 5 and 6 may not always be performed.

FIG. 5 is a flow diagram of an example method 500 of transporting incoming messages to a network of microcontrollers deployed to facilitate and control operation of a managed device, according to at least one embodiment. The managed device may be a computing component device, e.g., a processing device (GPU, CPU, PPU, DPU, ASIC, MPGA, and/or the like), a network controller device, and/or some other component device. At block 510, method 500 may include receiving, by a hub controller of a network of the managed device, one or more first data packets. The one or more first data packets may be jointly carrying a first message from a management controller, a host (e.g., BIOS, UEFI, host OS, etc.), and/or the like. In some embodiments, the one or more first data packets may be (or include) MCTP packets. The first message may be associated with a first unit of a plurality of units of the network of controllers. In one example embodiment, the plurality of units may include one or more of a power management unit, a temperature control unit, a GPU system processor, a foundation security processor, and/or the like. In some embodiments, each unit of the plurality of units may include (or be communicatively coupled or otherwise associated with) a respective unit controller of a plurality of unit controllers. In some embodiments, a single unit controller may serve multiple units.

At block 520, method 500 may continue with identifying (e.g., by the hub controller) that the one or more first data packets are associated with the first unit. In some embodiments, such identification may be performed by one or more hardware circuits of the hub controller (e.g., by analyzing the header(s) of the one or more first data packets) without invocation of software or firmware.

At block 530, method 500 may include forwarding the one or more first data packets to the first unit controller. In some embodiments, forwarding of the one or more first data packets to the first unit controller may be performed over a PRI bus.

At block 540, method 500 may continue with extracting, using the first unit controller, the first message from the one or more first data packets. In some embodiments, as indicated by block 542, a decryption of the first message may be performed, e.g., before or after the first message is extracted from the one or more first data packets. In some embodiments, decryption of the first message may be performed by an encryption/decryption circuit of the first unit controller.

At block 550, method 500 may continue with storing the first message in a memory associated with the first unit controller. In some embodiments, e.g., as indicated by block 552, storing the first message may be performed by the first unit controller executing a direct memory access write to the memory associated with the first unit controller. In some embodiments, as indicated by block 554, method 500 may include causing an interrupt signal to be communicated to a processing device, which may be performed responsive to the first message being stored in the memory associated with the first unit controller.

In some embodiments, operations of blocks 510-530 associated with handling of messages directed to the first unit (e.g., packets A1, A2 in FIG. 3) may be performed concurrently with handling of messages directed to a second unit (e.g., packets C1, C2 in FIG. 3). For example, the hub controller may receive one or more second data packets jointly carrying a second message from the external host, the second message associated with the second unit. At least one data packet (e.g., packet C1) of the one or more second data packets may be received after receiving at least one earlier-arrived packet (e.g., packet A1) of the one or more first data packets and prior to receiving at least one later-arrived packet (e.g., packet A1) of the one or more first data packets. Responsive to identifying that the one or more second data packets are associated with the second unit, the hub controller may forward the one or more second data packets to a second unit controller.

FIG. 6 is a flow diagram of an example method 600 of handling outbound messages in a network of microcontrollers deployed to facilitate and control operation of a managed device, according to at least one embodiment. The managed device may be a computing component device, e.g., a processing device (GPU, CPU, PPU, DPU, ASIC, MPGA, and/or the like) or a network controller device. At block 610, method 600 may include retrieving, by a second unit controller of the plurality of unit controllers, a second message from a memory associated with the second unit controller. (Even though operations of method 600 are illustrated in relation to the second unit controller, similar operations may be performed in relation to the first unit controller, a third unit controller, and/or any other controller of the network of controllers.) In some embodiments, e.g., as indicated by block 612, retrieving the second message may be performed by the second unit controller executing a direct memory access read from the memory associated with the second unit controller. In some embodiments, as indicated by block 614, the second message may be encrypted. In some embodiments, encryption of the second message may be performed by an encryption/decryption circuit of the second unit controller.

At block 620, method 600 may continue with generating, by the second unit controller, one or more second data packets. The one or more second data packets may be jointly carrying a second message to the management controller, a host software (e.g., OS of a host computer), BIOS, UEFI, or some other external device or module. In some embodiments, the one or more first data packets may be (or include) MCTP packets. The second message may be associated with an address (e.g., a destination address) of the corresponding recipient of the second message. In some embodiments, encryption of the second message may be performed after the message is fragmented into the one or more second data packets.

At block 630, method 600 may continue with communicating, by the second unit controller, the one or more second data packets to the hub controller. In some embodiments, communicating the one or more second data packets to the hub controller may be performed over the PRI bus.

At block 640, method 600 may continue with identifying, by the hub controller, that the one or more second data packets reference an address associated with at least one of the management controller or an external host.

At block 650, method 600 may continue with forwarding, by the hub controller, the one or more second data packets to the management controller.

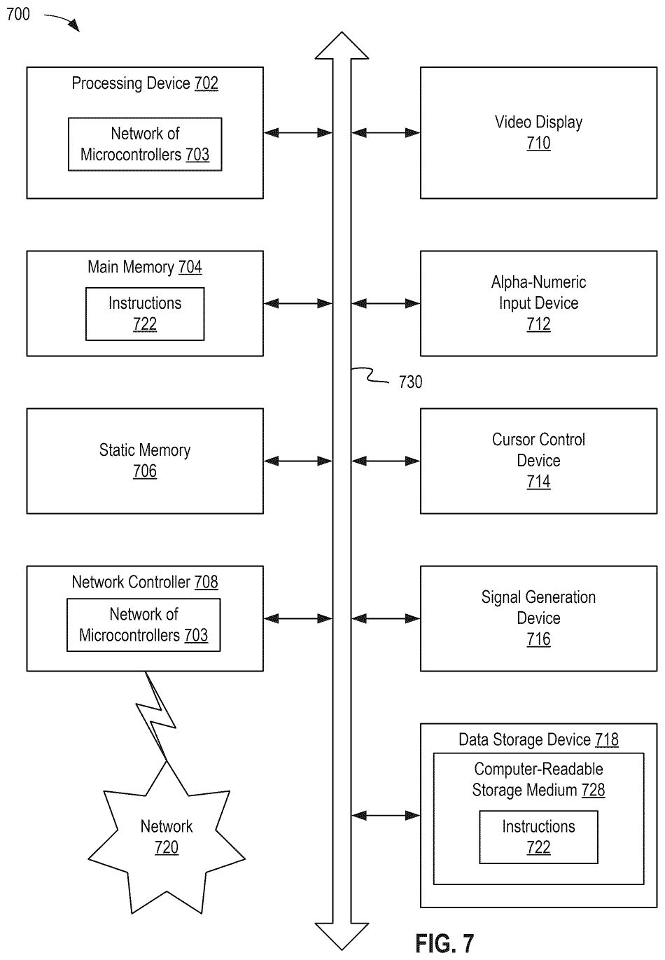

FIG. 7 depicts a block diagram of an example computer device 700 capable of supporting software-agnostic transport of messages to, from, and within managed devices, according to at least one embodiment. Example computer device 700 can be connected to other computer devices in a LAN, an intranet, an extranet, and/or the Internet. Computer device 700 can operate in the capacity of a server in a client-server network environment. Computer device 700 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 700 can include a processing device 702 (also referred to as a processor), a main memory 704 (e.g., read-only memory (ROM), flash memory, dynamic random access memory (DRAM) such as synchronous DRAM (SDRAM), etc.), a static memory 706 (e.g., flash memory, static random access memory (SRAM), etc.), and a secondary memory (e.g., a data storage device 718), which can communicate with each other via a bus 730.

Processing device 702 represents one or more general-purpose processing devices such as a microprocessor, central processing unit, or the like. More particularly, processing device 702 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 702 can also be one or more special-purpose processing devices such as a GPU, a PPU, a DPU, an ASIC, an FPGA, a DSP, network processor, or the like.

Example computer device 700 can further comprise a network controller 708, which can be communicatively coupled to a network 720. Example computer device 700 can further comprise a video display 710 (e.g., a liquid crystal display (LCD), a touch screen, or a cathode ray tube (CRT)), an alphanumeric input device 712 (e.g., a keyboard), a cursor control device 714 (e.g., a mouse), and an acoustic signal generation device 716 (e.g., a speaker).

Example computer device 700 can be a host device configured to execute methods 500-600 of facilitating software-agnostic transport of messages to, from, and within managed devices. Managed devices may include one or more processing devices 702, network controllers 708, and/or the like. Individual managed devices may include a network of microcontrollers 703 operating in accordance with embodiments of FIGS. 1-6.

Data storage device 718 can include a computer-readable storage medium (or, more specifically, a non-transitory computer-readable storage medium) 728 on which is stored one or more sets of executable instructions 722.

Executable instructions 722 can also reside, completely or at least partially, within main memory 704 and/or within processing device 702 during execution thereof by example computer device 700, main memory 704 and processing device 702 also constituting computer-readable storage media. Executable instructions 722 can further be transmitted or received over a network via network interface device 708.

While the computer-readable storage medium 728 is shown in FIG. 7 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other embodiment examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computing component device comprising:
an intra-device network comprising:
a plurality of units, each coupled with a unit controller of a plurality of unit controllers; and
a hub controller communicatively coupled to each unit controller of the plurality of unit controllers, wherein the hub controller is to:
receive one or more first data packets jointly comprising a first message from an external host; and
responsive to identifying that the one or more first data packets are associated with a first unit of the plurality of units, forward the one or more first data packets to the first unit controller of the plurality of unit controllers; and
wherein the first unit controller is to:
extract the first message from the one or more first data packets; and
store the first message in a memory associated with the first unit controller.

2. The computing component device of claim 1, wherein the first unit controller comprises a decryption circuit to decrypt the first message.

3. The computing component device of claim 1, wherein the first unit controller is further to:
responsive to the first message being stored in the memory associated with the first unit controller, causing an interrupt signal to be communicated to a processing device.

4. The computing component device of claim 1, wherein the computing component device comprises at least one of a processing device or a network controller device.

5. The computing component device of claim 1, wherein the plurality of units comprises one or more of:
a power management unit,
a temperature control unit,
a GPU system processor, or
a foundation security processor.

6. The computing component device of claim 1, wherein the one or more first data packets comprise Management Component Transport Protocol (MCTP) packets.

7. The computing component device of claim 1, wherein to store the first message, the first unit controller is to execute a direct memory access write to the memory associated with the first unit controller.

8. The computing component device of claim 1, wherein the hub controller forwards the one or more first data packets to the first unit controller over a Privileged Register Interface (PRI) bus.

9. The computing component device of claim 1, wherein forwarding the one or more first data packets by the hub controller to the first unit controller, extracting the first message from the one or more first data packets by the first unit controller and storing the first message in the memory associated with the first unit controller are performed by without software involvement.

10. The computing component device of claim 1, wherein the hub controller is further to:
receive one or more second data packets jointly comprising a second message from the external host, wherein at least one data packet of the one or more second data packets is received after receiving at least one earlier-arrived packet of the one or more first data packets and prior to receiving at least one later-arrived packet of the one or more first data packets; and
responsive to identifying that the one or more second data packets are associated with a second unit of the plurality of units, forward the one or more second data packets to a second unit controller of the plurality of unit controllers.

11. The computing component device of claim 1, wherein a second unit controller of the plurality of unit controllers is to:
retrieve a second message to the external host from a memory associated with the second unit controller;
generate one or more second data packets jointly comprising the second message; and
communicate the one or more second data packets to the hub controller; and
wherein the hub controller is further to:
responsive to identifying that the one or more second data packets reference an address associated with the external host, forward the one or more second data packets to the external host.

12. The computing component device of claim 11, wherein to retrieve the second message, the first unit controller is to execute a direct memory access read from the memory associated with the first unit controller.

13. A computing system comprising:
a host software;
a management controller communicatively coupled to the host software; and
a managed device communicatively coupled to the management controller, the managed device comprising:
a plurality of units, each coupled to a unit controller of a plurality of unit controllers; and
a hub controller communicatively coupled to each unit controller of the plurality of unit controllers, wherein the hub controller is to:
receive one or more first data packets jointly comprising a first message from the management controller;
responsive to identifying that the one or more first data packets are associated with a first unit of the plurality of units, forward the one or more first data packets to a first unit controller of the plurality of unit controllers; and
wherein the first unit controller is to:
extract the first message from the one or more first data packets; and
store the first message in a memory associated with the first unit controller.

14. The computing system of claim 13, wherein the managed device comprises at least one of a processing device or a network controller device.

15. The computing system of claim 13, wherein the plurality of units comprises one or more of:
a power management unit,
a temperature control unit,
a GPU system processor, or
a foundation security processor.

16. The computing system of claim 13, wherein a second unit controller of the plurality of unit controllers is to:
retrieve a second message to the host software from a memory associated with the second unit controller;
generate one or more second data packets jointly comprising the second message to the management controller; and
communicate the one or more second data packets to the hub controller; and
wherein the hub controller is further to:
responsive to identifying that the one or more second data packets reference an address associated with at least one of the host software or the management controller, forward the one or more second data packets to the management controller.

17. A method comprising:
receiving, by a hub controller of a network of a managed device, one or more first data packets jointly comprising a first message from a management controller;
identifying that the one or more first data packets are associated with a first unit of a plurality of units of the network, wherein each unit of the plurality of units is associated with a unit controller of a plurality of unit controllers;
forwarding the one or more first data packets to the first unit controller of the plurality of unit controllers;
extracting, using the first unit controller, the first message from the one or more first data packets; and
storing the first message in a memory associated with the first unit controller.

18. The method of claim 17, wherein the managed device comprises at least one of a processing device or a network controller device.

19. The method of claim 17, wherein the plurality of units comprises one or more of:
a power management unit,
a temperature control unit,
a GPU system processor, or
a foundation security processor.

20. The method of claim 17, further comprising:
retrieving, by a second unit controller of the plurality of unit controllers, a second message from a memory associated with the second unit controller;
generating, by the second unit controller, one or more second data packets jointly comprising the second message;
communicating, by the second unit controller, the one or more second data packets to the hub controller;
identifying, by the hub controller, that the one or more second data packets reference an address associated with at least one of the management controller or an external host; and
forwarding, by the hub controller, the one or more second data packets to the management controller.
